(19) United States
(12) Patent Application Publication
(10) Pub. No.: US 2025/0353542 A1
(43) Pub. Date: Nov. 20, 2025

(54) ELECTROMECHANICAL VEHICLE STEERING SYSTEM AND METHOD FOR PRODUCING SAME

(71) Applicant: Volkswagen Aktiengesellschaft, Wolfsburg (DE)

(72) Inventors: Heiko SCHUMANN, Braunschweig (DE); Thomas KNOPP, Vechelde (DE); André HUK, Braunschweig (DE)

(73) Assignee: Volkswagen Aktiengesellschaft, Wolfsburg (DE)

(21) Appl. No.: 19/285,486

(22) Filed: Jul. 30, 2025

Related U.S. Application Data
(63) Continuation of application No. PCT/EP2023/085958, filed on Dec. 14, 2023.

(30) Foreign Application Priority Data
Jan. 31, 2023 (DE) 10 2023 200 763.0

(51) Int. Cl. B62D 5/04; B62D 3/02

(52) U.S. Cl. CPC B62D 5/0424; B62D 3/02; B62D 5/0403; B62D 5/0442

(57) ABSTRACT

An electromechanical vehicle steering system comprising a housing, an electric motor having an axis of rotation, and a drop arm. The drop arm is axially movable in the direction of a longitudinal axis and the longitudinal axis extends in parallel with the axis of rotation of the electric motor. A gearbox couples the electric motor to the drop arm to translate a rotational movement of the electric motor into a linear movement of the drop arm. The gearbox comprises a toothed belt drive and a ball screw drive. A ball screw nut of the ball screw drive is in engagement with the drop arm and supports the drop arm. A toothed belt is tensioned by the adjustable bearing. The drop arm is also supported in the housing by a guide bush. The position of the guide bush can be adjusted in the housing radially to the drop arm.

This nonprovisional application is a continuation of International Application No. PCT/EP2023/085958, which was filed on Dec. 14, 2023, and which claims priority to German Patent Application No. 10 2023 200 763.0, which was filed in Germany on Jan. 31, 2023, and which are both herein incorporated by reference.

### FIELD OF THE INVENTION

The invention relates to an electromechanical vehicle steering system, which comprises a housing, an electric motor having a rotation axis, a drop arm having a longitudinal axis, the drop arm being arranged in the housing so as to be axially movable in the direction of the longitudinal axis, and the longitudinal direction running in parallel to the rotation axis of the electric motor, a gearbox mechanism via which the electric motor is drivably coupled to the drop arm for the purpose of translating a rotational movement of the electric motor into a linear movement of the drop arm, the gearbox mechanism comprising a toothed belt drive and a ball screw drive, a ball screw nut of the ball screw drive being in engagement with the drop arm and supporting the drop arm in the housing, the ball screw nut being supported on the housing via an adjustable bearing, and a toothed belt of the toothed belt drive being able to be tensioned via the adjustable bearing.

The invention further relates to a method for manufacturing an electromechanical steering system of this type.

### DESCRIPTION OF THE BACKGROUND ART

A generic electromechanical vehicle steering system is known from DE 10 2008 050 248 A1. In this case, a toothed belt drive is coupled to an output shaft of an electric motor via a first smaller toothed belt wheel and to a ball screw nut of a ball screw drive via a further larger toothed belt wheel, the ball screw nut being in operational engagement with a drop arm of the steering system. To set the belt pretensioning force, after the toothed belt has been placed onto the belt wheels of the steering system, the toothed rack is tilted with respect to the steering system housing in the unfixed state of the bearing of the ball screw drive until a predefined belt pretensioning force measured during the setting process is reached. The bearing of the ball screw drive is then fixed in the located position on the steering system housing. An additional tensioning and adjusting mechanism on the toothed belt drive is avoided hereby. The setting of the belt pretensioning force may take place in an automated manner. However, distortions may occur due to the tilting action for tensioning the toothed belt.

It is proposed in DE 10 2009 037 873 B4, in a modification of DE 10 2008 050 248 A1, which are both herein incorporated by reference, to first measure the toothed belt during the application of a predefined belt pretensioning force. Depending on the measurement result, the center distance between a first toothed belt wheel and a bearing unit for a further toothed belt wheel is then set by adjusting the position of the bearing unit in such a way that a predefined toothed belt pretensioning force is obtained on the subsequently mounted toothed belt. The further toothed belt wheel is then mounted on the bearing unit. Only afterward is the measured toothed belt mounted on the toothed belt wheels. A high setting accuracy of the toothed belt pretensioning force is to be achieved hereby, since possible tolerances of the toothed belt may be compensated for at the end of the process chain.

Since the toothed belt drive is adapted to the specifically mounted toothed belt during mounting, a complex preliminary measurement and classification of the toothed belts and toothed belt drives for the purpose of an individual assignment may be omitted.

A further advantage of the approach in DE 10 2009 037 873 B4 is that the fastening of the bearing unit may take place in a manner concealed by the toothed belt drive in particular by a toothed belt wheel. If the toothed belt assigned to the toothed belt drive has been measured, the setting and fixing of the bearing unit as well as the mounting of the toothed belt wheel upstream from or at the bearing unit may take place before the toothed belt is mounted. The structural design flexibility is increased hereby. The bearing unit and the associated belt wheel may be accommodated in a very compact manner in a housing, for example of a vehicle steering system. Since the toothed belt is measured during the application of a predefined belt pretensioning force, its strain behavior is also taken into account during mounting, by which means the scattering of the belt pretensioning force remains particularly low. The latter is important for a uniform steering feel in series production. In the approach proposed in DE 10 2009 037 873 B4, however, the toothed belt must be mounted in the pretensioned state, which is possible only with straight-toothed belts, whose running properties are less favorable than those of helically toothed belts.

A further possibility for ensuring the least possible scattering of the toothed belt pretensioning force is known from DE 10 2006 036 215 B4, which is incorporated herein by reference. The latter describes a method for mounting steering gearbox mechanisms of the type having toothed belt drives free of tensioning means, which is based on two toothed belt wheels having a fixed, non-adjustable center distance, which are coupled to each other via a pretensioned toothed belt.

The center distance of the toothed belt wheels is permanently predefined here. It is proposed in DE 10 2006 036 215 B4 to measure the actual center spacing of the toothed belt wheels for each steering gearbox mechanism with regard to a tolerance range for the center distance, to provide toothed belts in multiple belt classes, a classification taking place by means of a different length and/or width of the belts, and, in connection with the tolerance range for the center distance, all toothed belts within the belt class resulting in a toothed belt tension within a predefined tolerance range in the mounted state of the toothed belt, and to select a toothed belt from the associated belt class and to subsequently mount it for the actual center distance measured. However, this procedure is quite complex due to the provisioning of a multiplicity of different belts as well as due to the necessary selection process during mounting.

A further electromechanical vehicle steering system is known from DE 10 2010 034 698 A1, which is incorporated herein by reference. It is mounted as follows: The toothed belt wheels of the toothed belt drive are first mounted, at least one of the toothed belt wheels being axially displaced with respect to a gearbox mechanism component. The toothed belt is subsequently placed loosely on the toothed belt wheels. Afterwards, at least one toothed belt wheel is moved from its axially displaced position into the tensioning position for the purpose of tensioning the toothed belt. Finally, the initially axially displaced toothed belt wheel(s) is/are fixed in the tensioning position. The procedure makes it possible to fit toothed belts having toothing profiles which, due to geometry, may not be inserted axially onto the toothed wheels in the case of toothed belt drives which are only slightly or not at all axially displaced. At the same time, a defined belt tension may be ensured. To tension the toothed belt, the toothed belt wheel arranged on a ball screw nut, in particular, is rotated relative to the ball screw nut. An eccentric mechanism between a circumferential section of the ball screw nut and the toothed belt wheel facilitates the axial displacement mentioned above for the placement of the toothed belt as well as the subsequent tensioning by means of a relative rotation. However, the manufacturing of an eccentric mechanism of this type is complex.

A design having an eccentric mechanism is known from DE 103 10 492 A1, the eccentric mechanism, however, being provided in a different location than in DE 10 2010 034 698 A1. According to DE 103 10 492 A1, the electric motor and/or the drop arm is/are to be supported with the aid of an eccentric in such a way that the center distance between the output shaft and the drop arm is variable. In one design variant, the drop arm is received in a ball screw nut, which, in turn, is supported on an eccentric ring via a roller bearing. The eccentric ring, in turn, is supported in a steering system housing. A toothed belt of a toothed belt drive may be tensioned by rotating the eccentric ring.

The prior art explained above illustrates the complexity of the manufacturing of an electromechanical vehicle steering system comprising a toothed belt drive with regard to ensuring a uniform steering feel in series production.

### SUMMARY OF THE INVENTION

It is therefore an object of the present invention is to provide an alternative which is easy to manufacture and is also suitable to ensure a uniform steering feel in series productions with little complexity.

This object is achieved by an electromechanical vehicle steering system according to the invention. The vehicle steering system according to the invention is characterized, in particular, in that the drop arm is additionally supported in the housing via a guide bush, and the position of the guide bush is adjustable in the housing radially to the drop arm.

Distortions in the gearbox mechanism, in particular in the region of the ball screw drive, which may occur as a result of manufacturing tolerances when maintaining a uniform belt pretension, may be compensated for via the adjustable guide bush within the housing.

At the same time, the electromechanical vehicle steering system remains simple in terms of its structure as well as its mounting.

Since the toothed belt may be installed in the non-pretensioned state during mounting, straight-toothed belts as well as helically toothed belts may be used.

The approach according to the invention is suitable, in particular, for steer-by-wire systems in which toothing on the drop arm is no longer necessary for the engagement with a steering pinion.

The position of the drop arm may thus be influenced independently of each other at two points, namely via the adjustment of the position of the ball screw nut, on the one hand, and via the adjustment of the position of the additional guide bush, on the other hand. This facilitates a particularly great flexibility to compensate for possible manufacturing tolerances. Since the latter may be permitted to a greater extent than previously, the approach according to the invention also facilitates a reduction in manufacturing costs.

Compared to electromechanical vehicle steering systems in which the tensioning of the toothed belt wheel takes place by adjusting the position of the electric motor, in the approach according to the invention, the electric motor may be arranged on or in the housing so as to be non-adjustable, by which means a corresponding sealing point is eliminated.

Compared to electromechanical vehicle steering systems having a fixed center distance between the electric motor and the drop arm, the measurement of the necessary belt length as well as the classification of a tooth belt having a suitable length may be omitted.

For example, the guide bush may have a friction bearing, in which the drop arm is guided axially by a section and is secured against rotation around its longitudinal axis. In this case, the guide bush additionally takes on the function of an anti-rotation device of the drop arm.

A section having a motor receiving chamber for the electric motor can be fastened on the housing or molded thereon to form a single piece, while the electric motor includes an output shaft, on which a first toothed belt wheel of the toothed belt drive is rotatably fixedly arranged. The electric motor can be inserted axially into the motor receiving chamber from a side opposite the first toothed belt wheel. The mounting may be further simplified hereby.

The output shaft of the electric motor can be rotatably supported in the housing via a roller bearing, an outer ring of the roller bearing being supported on an inner wall shoulder of the housing. This permits a good support of the toothed belt span tensions, on the one hand, and a good accessibility of the toothed belt drive for mounting the toothed belt wheel, on the other hand.

The adjustable bearing can comprise a roller bearing and a bearing clamping device, an outer ring of the roller bearing being movable in the housing radially to the longitudinal axis of the drop arm and being able to be fixed to the housing with the aid of the bearing clamping device, a clamping of the bearing clamping device to the housing taking place radially outside a second toothed belt wheel rotatably fixedly arranged on the ball screw nut. The adaptation of the position of the ball screw nut may be very easily carried out hereby during the tensioning of the toothed belt wheel. The manufacturing of eccentric surfaces may be omitted.

The housing can form a single piece with a section having a gearbox mechanism receiving chamber, whose outer wall extends radially around the toothed belt drive, and the gearbox mechanism receiving chamber is closed on the end face by a gearbox mechanism cover, which has a through-opening for the drop arm. This makes the components for the toothed belt drive easily accessible during mounting. At the same time, the structure of the housing remains simple.

The object mentioned above is furthermore achieved by a method for manufacturing an electromechanical vehicle steering system of the type having an axis-aligned arrangement of a drop arm and an electric motor. The method is characterized by the following steps, namely: attaching the electric motor to a housing of the drop arm; inserting a ball screw nut having a roller bearing into a gearbox mechanism receiving chamber of the housing, the ball screw nut being designed to support the drop arm; prefixing the roller bearing on the housing; arranging toothed belt wheels on an output shaft of the electric motor as well as on the ball screw nut; loosely placing a toothed belt on the mounted toothed belt wheels; tensioning the toothed belt by radially displacing the roller bearing of the ball screw nut and fixing the roller bearing while the toothed belt is under tension; and providing a guide bush for guiding the drop arm and radially positioning the guide bush in the housing according to the position of the roller bearing of the ball screw nut and fixing the guide bush to the housing.

The steps may possibly be carried out in the order indicated in the present case; however, this is not obligatory. A method of this type may be implemented manually as well as possibly in an automated or semiautomated manner with little effort. In particular, the toothed belt tension may be adjusted hereby with a high degree of accuracy, despite a comparatively rough toleration of the toothed belt, distortions being able to be avoided in the ball screw drive.

The drop arm, together with the ball screw nut and the guide bush, may be moved in parallel in the housing radially to the longitudinal axis of the drop arm. This makes it possible to particularly effectively prevent the drop arm from tilting in the ball screw nut.

The electric motor and the ball screw nut can be inserted into the housing from opposite sides and in opposite directions.

The electric motor can be inserted into the motor receiving chamber with a first toothed belt wheel pre-mounted on an output shaft, the first toothed belt wheel being passed through a bearing point on the housing for the output shaft. The mounting may be further simplified by the formation of a structural subunit of this type.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein: the sole figure shows a longitudinal sectional view of an example of an electromechanical vehicle steering system according to the invention.

### DETAILED DESCRIPTION

The exemple in the figure shows an electromechanical vehicle steering system 1, which in the present case is designed as an example of a steer-by-wire steering system for a passenger car or a light commercial vehicle.

Electromechanical vehicle steering system 1 comprises a housing 2 as well as an electric motor 3 having a rotation axis A, a drop arm 4 having a longitudinal axis B, and a gearbox mechanism 5, via which electric motor 3 is drivably coupled to drop arm 4 for the purpose of translating a rotational movement of electric motor 3 into a linear movement of drop arm 4 in the direction of longitudinal axis B thereof.

Drop arm 4, in turn, is coupled to wheel supports via drop arm joints 6, so that a linear movement of drop arm 4 along its longitudinal axis B results in a steering angle of associated vehicle wheels.

For this purpose, drop arm 4 is arranged so as to be axially movable in housing 2 in the direction of longitudinal axis B. Longitudinal axis B of drop arm 4 runs in parallel to rotation axis A of electric motor 3.

Electric motor 3 may be flanged to a section of housing 2 which receives drop arm 4. It is also possible to arrange electric motor 3 in a motor receiving chamber 21 of housing 2, which is formed by an integral section 22 of housing 2.

Components of electric motor 3 can be provided as a power pack 31, which is mounted directly in motor receiving chamber 21 of section 22. The motor housing in this case is formed by integral wall sections of housing 2 of drop arm 4.

However, section 22 including motor receiving chamber 21 may, as mentioned above, be provided as a separate component and be fixedly mounted on further housing 2, which receives drop arm 4.

In all cases, the position of electric motor 3 with respect to housing 2 of drop arm 4 is fixed and not adjustable. The position of rotation axis A of electric motor 3 is thus permanently predefined. In the ideal case of a single-piece design of section 22 with housing 2 of drop arm 4, sealing points which would otherwise be necessary are omitted.

Gearbox mechanism 5 comprises a toothed belt drive 51 and a ball screw drive 55, which in the present case are drivably connected in series.

Toothed belt drive 51 includes a first toothed belt wheel 52, which is rotatably fixedly coupled to an output shaft 32 of electric motor 3, as well as a second toothed belt wheel 53 and a toothed belt 54 placed on these toothed belt wheels 52 and 53. Toothed belt 54 may have a straight toothing or a helical toothing.

Ball screw drive 55 has a ball screw nut 56, which is in engagement with a corresponding threaded section 41 of drop arm 4 via balls 56a and supports drop arm 4 in housing 2.

For this purpose, ball screw nut 56 is rotatably supported in housing 2, simultaneously secured against an axial displacement.

An adjustable bearing 57 can be provided for this purpose, which may be designed, for example, as a roller bearing. An inner ring 58 of adjustable bearing 57 is fastened to ball screw nut 56, while an outer ring 59 of the adjustable bearing is fixed on housing 2.

A bearing clamping device 60 may be provided for fastening adjustable bearing 57, with the aid of which outer ring 59 of adjustable bearing 57 is fixed both axially and radially with respect to housing 2.

In this connection, it should be noted that adjustable bearing 57 may be moved radially to longitudinal axis B of drop arm 4 prior to being fixed on housing 2 to facilitate a placement and tensioning of toothed belt 54 in this way.

Bearing clamping device 60 may be formed, for example, by a support plate or a retaining ring, which is axially clamped against housing 2 with the aid of threaded bolts 61 or the like, enclosing adjustable bearing 57.

A clamping of bearing clamping device 60 to housing 2 may preferably be carried out radially outside second toothed belt wheel 53, which is rotatably fixedly arranged on ball screw nut 56. Depending on the design of bearing clamping device 60, a clamping may also take place within the circumference of second toothed belt wheel 53, or example in that corresponding through-openings are provided on the latter, which permit an access to suitable clamping means, for example threaded bolts 61.

In a modification thereof, other fastening mechanisms may also be provided for attaching outer ring 59 of an adjustable bearing 57. In particular, it is possible to screw outer ring 59 of adjustable bearing 57 directly to housing 2. For this purpose, a corresponding flange may possibly be molded on the outer circumference of outer ring 59.

Since the manufacture and processing of rolling element steels are generally complex, the fastening with the aid of a bearing clamping device 60 is, however, to be preferred.

As mentioned above, drop arm 4 is supported on housing 2 via ball screw nut 56 and adjustable bearing 57. A tensioning of toothed belt 54 of toothed belt drive 51 takes place by radially displacing adjustable bearing 57 relative to housing 2, moving longitudinal axis B of drop arm 4 relative to housing 2 as well as to rotation axis A of electric motor 3, and by subsequently fixing adjustable bearing 57 and thus ultimately also drop arm 4 in this position.

To avoid distortions in ball screw drive 55, drop arm 4 is also supported in housing 2 via a guide bush 70. In other words, in addition to a first bearing point L1 on ball screw drive 55, a separate second bearing point L2 may be provided for drop arm 4 within housing 2 by means of guide bush 70.

In the present case, the position of guide bush 70 is adjustable in housing 2 radially to drop arm 4. During a tensioning of toothed belt 54, the position of drop arm 4 may thus be radially adjusted in the region of guide bush 70, for example to avoid a tilting of drop arm 4 in ball screw drive 55. In series production, this has a positive effect on a uniform steering feel over the course of many vehicle steering actions.

In particular, guide bush 70 may have a friction bearing, in which drop arm 4 is guided axially by a section 42 and is additionally secured against rotation around its longitudinal axis B.

With regard to an easy mounting of the electromechanical vehicle steering system, electric motor 3 may be provided with an output shaft 32, on which first toothed belt wheel 52 of toothed belt drive 51 is rotatably fixedly arranged. Electric motor 3 is preferably inserted axially into motor receiving chamber 21 from a side opposite first toothed belt wheel 52.

Output shaft 32 of electric motor 3 may also be rotatably supported in housing 2 via a roller bearing 33, an outer ring 34 of this roller bearing 33 being supported on an inner wall shoulder 23 of housing 2.

Roller bearing 33 of output shaft 32 is arranged axially between electric motor 3 and first toothed belt wheel 51.

Motor receiving chamber 21 may be separated by roller bearing 33 of output shaft 32 from a section 24, which has a gearbox mechanism receiving chamber 25 and is preferably designed to form a single piece with housing 2. Gearbox mechanism 5, including its toothed belt drive 51 and ball screw drive 55, may be arranged in this gearbox mechanism receiving chamber 25.

An outer wall of section 24 preferably extends radially around toothed belt drive 51. Gearbox mechanism receiving chamber 25 is preferably open on the end face over the entire region of toothed belt drive 51, enabling the components of toothed belt drive 51 to be very easily mounted. After mounting, gearbox mechanism receiving chamber 25 may be closed on the end face by a gearbox mechanism cover 26, which has a through-opening for drop arm 4.

Similarly, a motor cover 27 may be provided on motor receiving chamber 21, which is mounted after mounting electric motor 3 or a corresponding power pack 31.

An electromechanical vehicle steering system of the type having an axis-aligned arrangement of drop arm 4 and electric motor 3, as described above, may be manufactured in the manner explained in greater detail below.

The manufacturing process involves first attaching electric motor 3 on housing 2 of drop arm 4. In particular, this may be an insertion of electric motor 3 or a corresponding power pack 31 into motor receiving chamber 21 of housing 2. If motor receiving chamber 21 is provided by means of a separate housing component, this separate housing component is first fastened to housing 2 of drop arm 4. The attachment of electric motor 3 may also include a fixed flanging of electric motor 3 onto housing 2 of drop arm 4. The position of rotation axis A of electric motor 3 relative to housing 2 is fixed thereby and, as such, may no longer be changed.

The manufacturing process further involves inserting ball screw nut 56, including an adjustable bearing 57, in particular a roller bearing, into gearbox mechanism receiving chamber 25 of housing 2, ball screw nut 56 being designed to support drop arm 4, as explained above.

Drop arm 4 may be mounted simultaneously with ball screw nut 56. However, it is also possible to install drop arm 4 only after the installation of ball screw nut 56.

Adjustable bearing 57 or the roller bearing is prefixed hereby on housing 2, for example by affixing threaded bolts 61.

An arrangement of toothed belt wheels 52 and 53 on output shaft 32 of electric motor 3 as well as on ball screw nut 56 further takes place.

In particular, second toothed belt wheel 53 may be mounted on ball screw nut 56 after the prefixing of adjustable bearing 57.

First toothed belt wheel 52 may already be provided when electric motor 3 is mounted on housing 2; however, it may also be attached later on to output shaft 32 already mounted on housing 2.

If electric motor 3, including first toothed belt wheel 52 premounted on output shaft 32, is inserted into motor receiving chamber 21, first toothed belt wheel 52 may be passed through a bearing point on housing 2 for output shaft 32.

A placement of toothed belt 54 onto mounted toothed belt wheels 52 and 53 takes place in the loose, untensioned state of toothed belt 54. The prefixing of adjustable bearing 57 is set accordingly for this purpose.

After the placement of toothed belt 54, a tensioning of same takes place by radially displacing adjustable bearing 57 of ball screw nut 56 until a desired toothed belt tension is reached. The position of longitudinal axis B of drop arm 4 relative to housing 2 is moved in the radial direction of longitudinal axis B.

Adjustable bearing 57 is then fixed with toothed belt 54 tensioned, the set toothed belt tension being maintained.

According to the invention, guide bush 70 is also provided on housing 2 as second bearing point L2 for guiding drop arm 4. During the tensioning of toothed belt 54, a radial positioning of guide bush 70 may take place in the housing 2 according to the position of adjustable bearing 57 of ball screw nut 56, for the purpose of avoiding distortions, as well as a fixing of guide bush 70 to housing 2.

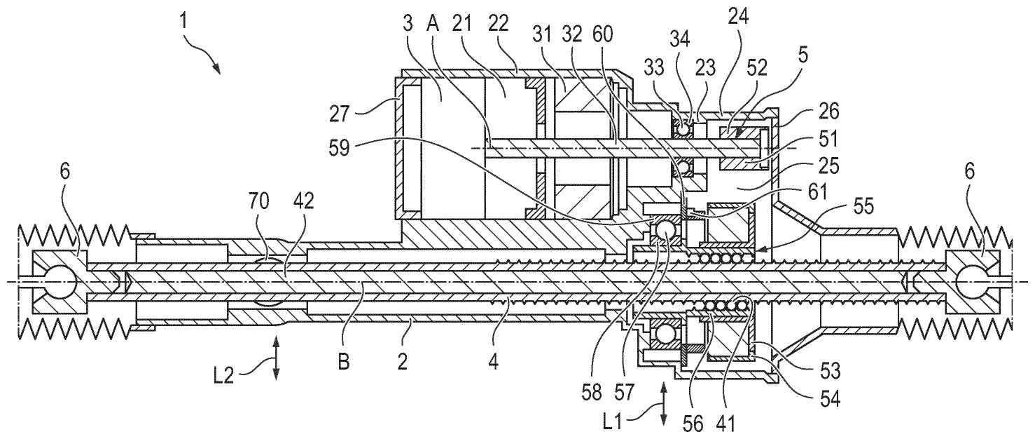

During the tensioning of toothed belt 54, drop arm 4, together with ball screw nut 56 and guide bush 70, may be moved essentially in parallel in housing 2 radially to longitudinal axis B of drop arm 4, as is indicated in FIG. 1 by double arrows at bearing points L1 and L2. The movement takes place transversely or radially to longitudinal axis B of drop arm 4.

Electric motor 3 and ball screw nut 56 may be inserted into housing 2 from opposite sides and in opposite directions. The corresponding insertion openings of housing 2, which is preferably designed as a single piece, are subsequently closed by covers 26 and 27. A sealing by bellows may be carried out between housing 2 and drop arm joints 6.

The invention was explained in greater detail above on the basis of an example and additional modifications. In particular, individual technical features, which were explained above in the context of other individual features, may be implemented independently thereof as well as in combination with other individual features, even if this is not expressly described, provided that it is technically feasible. The invention is therefore expressly not limited to the example described and the modifications specifically mentioned.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electromechanical vehicle steering system comprising:
a housing;
an electric motor having a rotation axis;
a drop arm having a longitudinal axis, the drop arm being arranged in the housing so as to be axially movable in a direction of the longitudinal axis, the longitudinal axis running substantially in parallel to the rotation axis of the electric motor;
a gearbox, via which the electric motor is drivably coupled to the drop arm for translating a rotational movement of the electric motor into a linear movement of the drop arm, the gearbox comprising a toothed belt drive and a ball screw drive;
a ball screw nut of the ball screw drive being in engagement with the drop arm and supporting the drop arm in the housing, the ball screw nut being supported on the housing via an adjustable bearing;
a toothed belt of the toothed belt drive adapted to be tensioned via the adjustable bearing; and
a guide bush supporting the drop arm in the housing, a position of the guide bush being adjustable in the housing radially to the drop arm.

2. The electromechanical vehicle steering system according to claim 1, wherein the guide bush has a friction bearing, in which the drop arm is guided axially by a section and is secured against rotation around its longitudinal axis.

3. The electromechanical vehicle steering system according to claim 1, wherein a section having a motor receiving chamber for the electric motor is fastened to the housing or is molded to form a single piece therewith, wherein the electric motor has an output shaft, on which a first toothed belt wheel of the toothed belt drive is rotatably fixedly arranged, and wherein the electric motor is inserted axially into the motor receiving chamber from a side opposite the first toothed belt wheel.

4. The electromechanical vehicle steering system according to claim 3, wherein the output shaft of the electric motor is rotatably supported in the housing via a roller bearing, an outer ring of the roller bearing being supported on an inner wall shoulder of the housing.

5. The electromechanical vehicle steering system according to claim 1, wherein the adjustable bearing comprises a roller bearing and a bearing clamping device, an outer ring of the roller bearing is movable in the housing radially to the longitudinal axis of the drop arm and is able to be fixed to the housing via the bearing clamping device, and wherein a clamping of the bearing clamping device to the housing is carried out radially outside a second toothed belt wheel of the toothed belt drive rotatably fixedly arranged on the ball screw nut.

6. The electromechanical vehicle steering system according to claim 1, wherein the housing forms a single piece with a section having a gearbox receiving chamber whose outer wall extends radially around the toothed belt drive, and wherein the gearbox receiving chamber is closed on the end face by a gearbox cover, which has a through-opening for the drop arm.

7. A method for manufacturing an electromechanical vehicle steering system having an axis-aligned arrangement of a drop arm and an electric motor, the method comprising:
attaching the electric motor to a housing of the drop arm;
inserting a ball screw nut having a roller bearing into a gearbox receiving chamber of the housing, the ball screw nut being designed to support the drop arm;
prefixing the roller bearing on the housing;
arranging toothed belt wheels of a toothed belt drive on an output shaft of the electric motor as well as on the ball screw nut;
loosely placing a toothed belt of the toothed belt drive on the mounted toothed belt wheels;
tensioning the toothed belt by radially displacing the roller bearing of the ball screw nut and fixing the roller bearing while the toothed belt is under tension;
providing a guide bush for guiding the drop arm, and radially positioning the guide bush in the housing according to the position of the roller bearing of the ball screw nut; and
fixing the guide bush to the housing.

8. The method according to claim 7, wherein the drop arm, together with the ball screw nut and the guide bush, is movable in parallel in the housing radially to the longitudinal axis of the drop arm.

9. The method according to claim 7, wherein the electric motor and the ball screw nut are inserted into the housing from opposite sides and in opposite directions.

10. The method according to claim 7, wherein the electric motor, including the first toothed belt wheel premounted on the output shaft, is inserted into the motor receiving chamber, the first toothed belt wheel being passed through a bearing point on the housing for the output shaft.
